(19) United States
(12) Patent Application Publication
(10) Pub. No.: US 2020/0207002 A1
(43) Pub. Date: Jul. 2, 2020

(54) EXTRUSION DIE WITH IMPROVED EXIT GAP CONTROL

(71) Applicant: Peter F. Cloeren, Orange, TX (US)

(72) Inventor: Peter F. Cloeren, Orange, TX (US)

(21) Appl. No.: 16/234,943

(22) Filed: Dec. 28, 2018

(51) Int. Cl. B29C 48/31; B29C 48/255; B29C 48/92; B29C 48/78; B29C 48/30

(52) U.S. Cl. CPC B29C 48/313; B29C 48/255; B29C 48/92; B29C 2948/92647; B29C 48/302; B29C 2948/92904; B29C 48/78

(57) ABSTRACT

An extrusion die including a die body having a movable die lip, is provided with improved automated control of the exit orifice through which a flowable polymer is extruded. The automated control is provided by lip adjustment assemblies each of which includes a thermally responsive translator and each of which is in engagement with the movable die lip. Beneficially, the lip adjustment assemblies are also in engagement with a support structure located to reduce the effect of flow pressure-induced deflection. Improved automated control of the movable lip and the exit orifice gap provides a web having a prescribed thickness profile without manual intervention being required.

### FIELD OF THE INVENTION

This invention relates to a slot die for forming a flowing mass to a prescribed thickness and width, particularly useful for forming polymeric films, sheets and coatings.

### BACKGROUND OF THE INVENTION

Mass flow control through a wide slot exit orifice is inversely proportional to flow resistance. Flow resistance may be quantified by the equation ΔP=12ηLQ/(WH³), where: P is flow resistance measured in pressure, η is the fluid viscosity, L is the length of the flow channel in the main flow direction, Q is the mass flow rate of the fluid, W is the width of the flow channel, and H is the height of the gap.

As can be appreciated from the foregoing equation, changes to the height of the gap have an exponential effect on flow volume. By way of example, for a typical cast film die extruding a nominal 3.5 MFI LLDPE at a specific output rate of 6 kg/cm width/hr operating at a nominal operating exit orifice gap of 0.6 mm, a 16% (corresponding to about 100 microns) local change of the exit orifice gap at a selected point along width W would result in a change of 25% in the corresponding volumetric flow rate. In another example, for a typical cast PP film process extruding a nominal 8 MFR CoPP at a specific output rate of 3.7 kg/cm width/hr having a nominal operating exit orifice gap of 0.9 mm, a 10% (corresponding to 100 microns) local change of the exit orifice gap at a selected point across width W results in a 16% change in the corresponding volumetric flow rate. As can be appreciated from these examples, the relationship between gap change and volumetric flow rate is exponential.

Given that the quality standards of thickness variation across an extruded film width is preferably within 20≤±1.5%, precision regulation of the exit orifice gap profile is essential.

However, when extruding thermoplastic polymers, a thermally homogenous flow stream is not consistently obtainable. All thermoplastic polymers exhibit a viscosity dependent on temperature. Thermal inhomogeneities, common in extrusion, cause localized variations in the mass flow volume across the width of the flow stream. Such inhomogeneities may be continuous or varying during extrusion. Ambient environment variables, and changing process variables affecting local mass flow, make the extrusion process an imperfect process. Accordingly, in practice, it is necessary for the exit orifice gap of an extrusion die to be continuously adjusted at discrete locations by a plurality of lip adjustment means along the width of the exit orifice during operation.

Extrusion dies having adjustable discharge orifices are widely known, as exemplified by U.S. Pat. No. 2,938,231 to Lowey, U.S. Pat. No. 3,940,221 to Nissel, U.S. Pat. No. 4,281,980 to Hoagland et al., U.S. Pat. No. 4,454,084 to Smith et al., U.S. Pat. No. 4,514,348 to Iguchi et al., U.S. Pat. No. 4,726,752 to VanDun, U.S. Pat. No. 4,781,562 to Sano, U.S. Pat. No. 5,051,082 to Hatori et al., U.S. Pat. No. 5,020,984 to Cloeren et al., U.S. Pat. No. 5,208,047 to Cloeren et al., U.S. Pat. No. 5,888,556 to Cloeren et al., U.S. Pat. No. 8,491,296 to Nakano, and U.S. Pat. No. 9,700,911 to Nakano.

Lowey, Jr. '231 describes an extrusion die that includes remote control of a plurality of thermally responsive translators (elongated adjustment bolts 26), by thermal expansion and contraction thereof, in threaded engagement with an adjustable member of the die exit orifice to change the thickness profile of an extrudate being discharged from the extrusion die.

Nissel '221 describes an extrusion die having computerized control of thermally responsive translators (elongated adjustment rods 60), by thermal expansion and contraction thereof, in engagement with an adjustable lip of the exit orifice of an extrusion die to control the thickness profile of an extrudate exiting therefrom.

Smith et al. '084 also describes an extrusion die having automated remote control of thermally responsive translators (elongated adjusting bolts 22) in threaded engagement with an adjustable lip of the exit orifice of the extrusion die, and that expand and contract in response to a signal proportional to measurement of the thickness profile of an extruded web.

However, a drawback of the foregoing extrusion dies is that intermittent manual adjustment of the exit orifice gap by lip adjusting bolts is required to produce an optimized thickness profile of the extruded web. The extent of manual intervention varies depending on many factors including initial setup of the exit orifice gap, extrusion process stability, polymer changes, process stability and the like.

In operation, an extrusion die sits proximate to cooling rolls or belts operating at relatively high speeds (up to 600-700 meters/minute) and/or with high pinch point forces between opposing cooling rolls (for illustrative examples, see Lowey '231, FIG. 3; Smith '084, FIG. 4; Hoagland '980, FIG. 4; and Nakano '911, FIGS. 5A-5B). It is desirable, if not a requisite, to provide ever safer working environments for machine operators and limit or remove human intervention proximate to such high speed and/or pinch point areas, thus limiting access to the die for manual manipulation/intervention.

### SUMMARY OF THE INVENTION

The present invention provides an extrusion die with automated lip adjustment means that advantageously reduce or eliminate the necessity of manual lip gap adjustment. To this end, the present invention provides a lip adjustment support structure advantageously located to reduce the effect of pressure induced displacement of the lip adjustment assembly by die body deflection. Furthermore, the present invention beneficially provides a safer working environment by limiting, if not eliminating, adjustment of the lip gap by human intervention. Moreover, the present invention reduces displacement of an adjustable lip resulting from die body deflection. Another major benefit of the present invention is significant energy savings.

In accordance with the foregoing, the present invention is directed to an extrusion die comprising a die body and a plurality of thermally responsive translators. The extrusion die further comprises a flow channel having a main flow direction and comprising an upstream flow channel portion in communication with a transverse-flow providing manifold and with a downstream flow channel portion comprising an exit orifice. The die body comprises a movable lip for controlling the gap of the exit orifice.

The thermally responsive translators are linearly movable. Beneficially, the thermally responsive translators are disposed in a spaced away relationship from the die body for reducing thermal cross-talk of the thermally responsive translators with the die body.

Advantageously, a plurality of automated lip adjustment means comprising the thermally responsive translators, are disposed between the movable lip and a support structure for the lip adjustment means. Beneficially, the support structure is located upstream of the backline of the transverse flow-providing manifold. Conveniently, the support structure may be secured to the die body by a plurality of fasteners or by welding. Alternatively, the support structure may be unitary with the die body. A relatively further upstream location of the support structure from the manifold backline is beneficial.

Additional advantages and beneficial features of the present invention are set forth in the drawing and detailed description, and in part will become apparent to those skilled in the art upon examination of the drawing and detailed description, or may be learned by practice of the invention. In the drawing and detailed description, there is shown and essentially described a preferred embodiment of this invention, simply by way of illustration of the invention. As described and will be realized, this invention is capable of other modifications in various respects, all without departing from the invention. Accordingly, the drawing and the detailed description are to be regarded as illustrative in nature, and not as restrictive.

### BRIEF DESCRIPTION OF THE DRAWING

Reference is now made to the accompanying drawing which forms a part of the specification of the present invention, and which illustrates a preferred embodiment of the present invention. Some details have been omitted from the drawing for simplification or clarity.

FIG. 1 illustrates a cross-section of a current state of the art extrusion die generally consistent with the extrusion die prior art illustrated in Cloeren U.S. Pat. No. 5,888,556;

FIG. 2 is a perspective view of a preferred embodiment of an extrusion die in accordance with the present invention;

FIG. 3 is a cross-section of the extrusion die of FIG. 2 substantially taken along line 3-3 of FIG. 2, which illustrates further details including those of an automated lip adjustment assembly;

FIG. 4 illustrates the results of a Finite Elemental Analysis that depict the displacement of the mating die bodies that results from flow pressure deflection forces, for the prior art extrusion die of FIG. 1; and

FIG. 5 illustrates the results of a Finite Elemental Analysis that depict the displacement of the mating die bodies that results from flow pressure deflection forces, for the inventive extrusion die of FIGS. 2 and 3.

### DETAILED DESCRIPTION OF THE INVENTION

In early versions of extrusion dies having thermally actuated lip adjustment assemblies, the thermally responsive translators or heat-conducting assemblies that include thermally responsive translators were commonly positioned near, and in general alignment with, an exterior surface of the die apparatus, as generally illustrated by Lowey '231, Nissel '221, and Cloeren et al. '984. As a result, undesirable thermal cross-talk between the thermally responsive translators and the extrusion dies occurred, even when a thermally insulating layer was interposed. This undesirable thermal cross-talk limited the effectiveness and/or responsiveness of the control of the lip gap.

Although reducing thermal cross-talk by positioning a portion of the length of elongated thermally responsive translators spaced away from (not near and not in general alignment with) the die body, as generally illustrated, but not described, by Smith et al. '084 and Cloeren et al. '556, by and large has become the industry standard of today, I have now come to recognize a heretofore unrealized nexus between die body deflection (discussed below) and exit orifice gap control: that the exit gap adjustment assembly of this type of prior art is mounted on a portion of the extrusion die that is subject to significant undesirable displacement coincident with die body deflection.

I have now come to realize that a solution exists by supporting the lip adjustment assemblies by a support structure beneficially located behind the manifold backline of the extrusion die. Although Nissel '221 and Cloeren '984, illustrate a support structure (“projection 61” of Nissel '221, and “extension 40” of Cloeren '984) located behind the manifold backline, this design feature was abandoned in favor of technology of the type generally illustrated by Cloeren '556 that advantageously spaces thermally responsive translators away from the die body, with reduction of the thermal cross-talk defect.

As described by Cloeren et al. U.S. Pat. No. 9,067,351, Cloeren U.S. Pat. No. 5,234,649 and Wilson et al. U.S. Pat. No. 5,494,429, die bodies are subject to deflection in response to internal pressures resulting from the extrusion of a viscous fluid therethrough. Pressure drop through, and corresponding deflection of, an extrusion die varies in response to differing polymer viscosity and/or process variables. The internal extrusion pressures in a die can be significant; for example, as high as 150 kg/cm², commonly about between 50-100 kg/cm², and can be as low as, for example 10 kg/cm² with very low viscosity liquid fluids. In addition, it is common for users of extrusion dies to have changing production requirements which affect the pressure drop through, and thereby deflection of, the die from one production campaign to the next production campaign.

Die body deflection not only negatively affects the mass flow distribution of a fluid across the transverse width of the die flow channel, which requires corrective action by lip gap adjustment, but also negatively affects the exit orifice gap profile across width W. Thus, local adjustments of the exit orifice gap profile, often by undesirable manual intervention via lip adjusting screws, is required to optimize the thickness profile of the extrudate.

Die body deflection is inherent in the extrusion process. The amount and form of the deflection is dependent on many factors including operating pressure drop through the die, the pressure drop distribution through the die flow channel, the mechanical construction of the die, and the flow channel design of the die. In high pressure drop applications, deflections of a die lip can be as high as 0.5 mm or more, and commonly in the range of 0.2-0.4 mm. When extrusion die bodies deflect, (i) most of the deflection affects the die body that includes an adjustable lip due to its inherently weaker structure compared to the opposing rigid or fixed lip die body, (ii) the die body including the lip adjustment assembly of prior art systems is displaced, and (iii) the operating lip gap changes due to flow pressure-induced displacement.

Nakano U.S. Pat. Nos. 8,491,296 and 9,700,911 teach automated lip adjustment means via a lever arm responsive to opposing bellows operated using compressed air, and connected to an adjustable lip. The lever arm pivots about a fulcrum 30 or fulcrum 32, illustrated in the '296 and '911 patents respectively, located downstream of the manifold backline of the extrusion die. Thus, fulcrums 30, 32 are subject to displacement by die body deflection.

It is desirable to (i) minimize lip gap deflection, and (ii) maximize the exit gap adjustment capabilities by beneficially minimizing the displacement of lip adjustment assembly structure. Accordingly, placement of the lip adjustment support structure behind the manifold backline of the die is found to be beneficial by the present invention.

In this description, relative terms such as “upper”, “lower”, “behind”, and the like have been used particularly with reference to the drawing to assist understanding. Similarly, the terms “upstream” and “downstream” have been used with reference to the main direction of fluid flow through the apparatus to the exit orifice. By the term “discrete” is meant “individually separate and distinct”. By the term “unitize” is meant to “combine into one unit”.

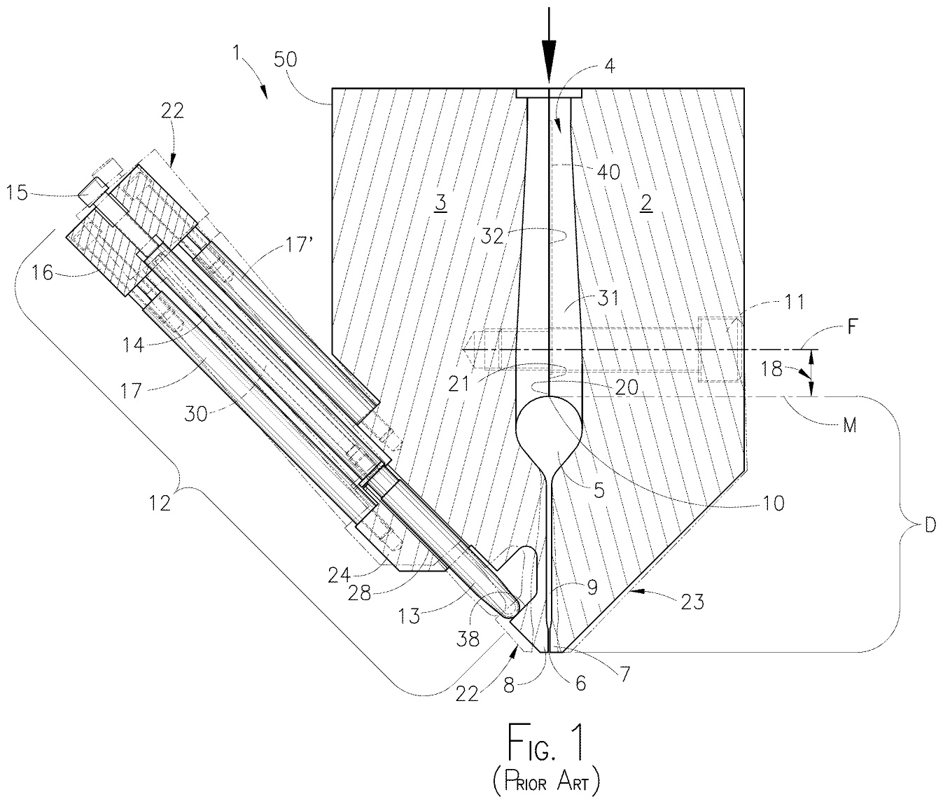

Referring to FIG. 1, a prior art extrusion die 1 is conveniently constructed of a first die body 2 and a second body 3. Die assembly 1 includes a flow channel 4 comprising a flow inlet channel 31 in fluid communication with a transverse flow-providing manifold 5, and a flow channel portion 9 providing fluid communication to adjustable exit orifice 6 formed by opposing lips 7, 8. The main direction of fluid flow from flow channel inlet 4 to exit orifice 6 is indicated by an enlarged arrow. Opposing die bodies 2, 3 are conveniently fastened together by a plurality of body bolts 11 (one bolt indicated) spaced apart from one another along the die width. A parting line 32 is defined by opposing faces 20,21 of die bodies 2,3. Seal surfaces 20,21 are situated between flow channel 4 and a seal undercut 40.

Die assembly 1 further includes a plurality of automated lip adjustment assemblies 12 spaced apart from one another along the width of die body 3. Assemblies 12 provide discrete control of the gap of exit orifice 6 along the width of the exit orifice. Each adjustment assembly 12 is in engagement with, and disposed between, adjustable lip 8 of die body 3 and a support structure 16.

A thermally responsive translator 14 of each adjustment assembly 12 is in engagement with, and disposed between, a push rod 13 and an adjustment screw 15. Each thermal translator includes a heating element 30, and is configured to expand and contract in response to change of automated control input. Push rods 13 are in contact with a face 38 of lip 8. A projection 24 of die body 3 includes a plurality of guide channels 28 (one shown) through each of which a push rod extends. A relatively greater portion of the length of each of elongated thermal translators 14 is spaced away from die body 3, and spaced away from a generally parallel relationship with die body 3, in particular from a proximate face 50 of die body 3.

Support 16 for lip adjustment assembly 12 is secured to, and thus supported by die body 3 via a plurality of tie rods 17, 17′ disposed between support 16 and projection 24 of die body 3, by structural means generally consistent with the disclosure of Cloeren prior art U.S. Pat. No. 5,888,556, the pertinent portion of which is hereby incorporated by reference.

In operation, adjustment screw 15 of lip adjustment assembly 12 is engaged with support 16 and cooperates with thermal translator 14 to exert a force on adjustable lip 8 to facilitate adjustment of the gap of exit orifice 6. However, structure 16 is subject to undesirable displacement by die body deflection forces. During operation, die bodies 2,3 are subject to flow pressure-induced deflection, that is to say, die bodies 2,3 are subject to displacement, as illustratively depicted by phantom lines 22,23, by forces generated by internal operating pressure resulting from the flow resistance of the fluid being extruded therethrough. As illustratively depicted by phantom lines 22,23, the deflection of die bodies 2,3 pivots about a fulcrum region 18.

Fulcrum region 18 is defined by a manifold backline 10 and a fulcrum line F, which is indicated on or about the centerline of fastener 11. Manifold backline 10 is further indicated for clarity, by a phantom line M that is generally parallel to fulcrum line F. Body bolts 11 exert sufficient force on opposing surfaces 20,21 to prevent separation, that is to say, the body bolts do not allow flow pressure-induced deflection of opposing surfaces 20,21 in the region between manifold backline 10 and fulcrum line F, and thereby create fulcrum region 18.

However, under operating pressure and downstream of manifold backline 10, die bodies 2, 3 are displaced in a deflection region D by forces resulting from the internal operating pressure through die flow channel portions 5, 9 and exit orifice 6 collectively, as illustratively depicted by phantom lines 22, 23. Die body bolts 11 isolate the portion of the die bodies upstream of fulcrum line F from deflection region D. Deflection region D is defined by the manifold backline 10 and exit orifice 6. Due to a cantilever action pivoting about fulcrum region 18, support 16 is, as illustratively depicted by phantom line 22, displaced more than mounting projection 24 of die body 3. This amplified displacement of support 16 in turn places higher demand on thermal translators 14, to the extent that they may be displaced beyond their thermal adjustment range, thus requiring undesirable manual intervention of the gap of the exit orifice via adjustment screws 15.

The displacement by die body deflection forces in deflection region D varies depending upon specific process conditions, including fluid viscosity, specific throughput rate, die body design, and the die and flow channel design including that of the exit orifice.

It should be understood that the foregoing description and that the description related to FIG. 1 that follows below, include details that I have now come to recognize as a result of this invention.

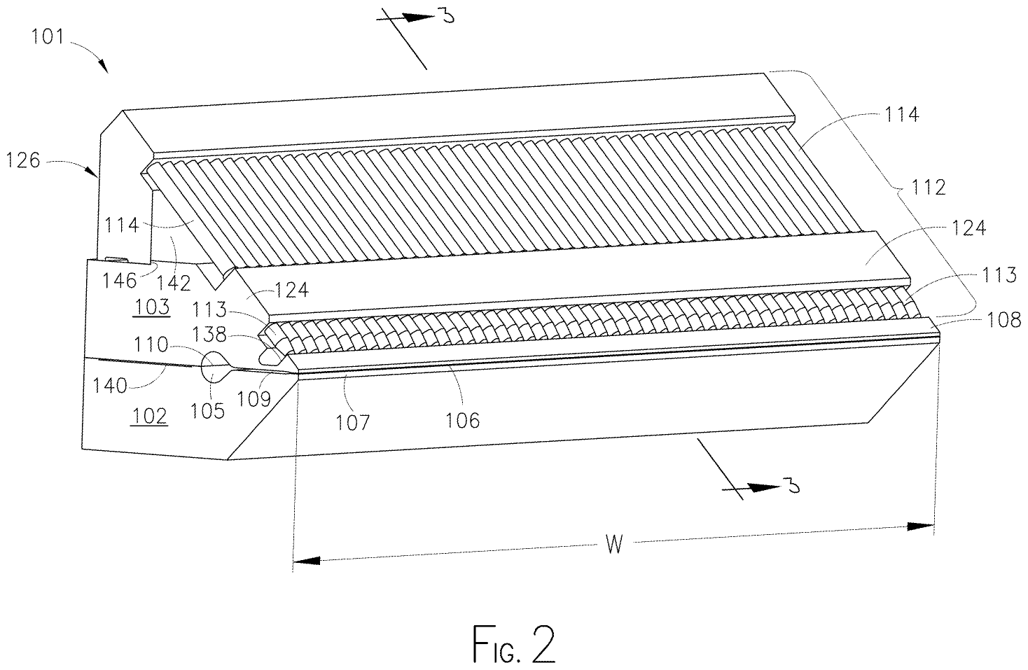

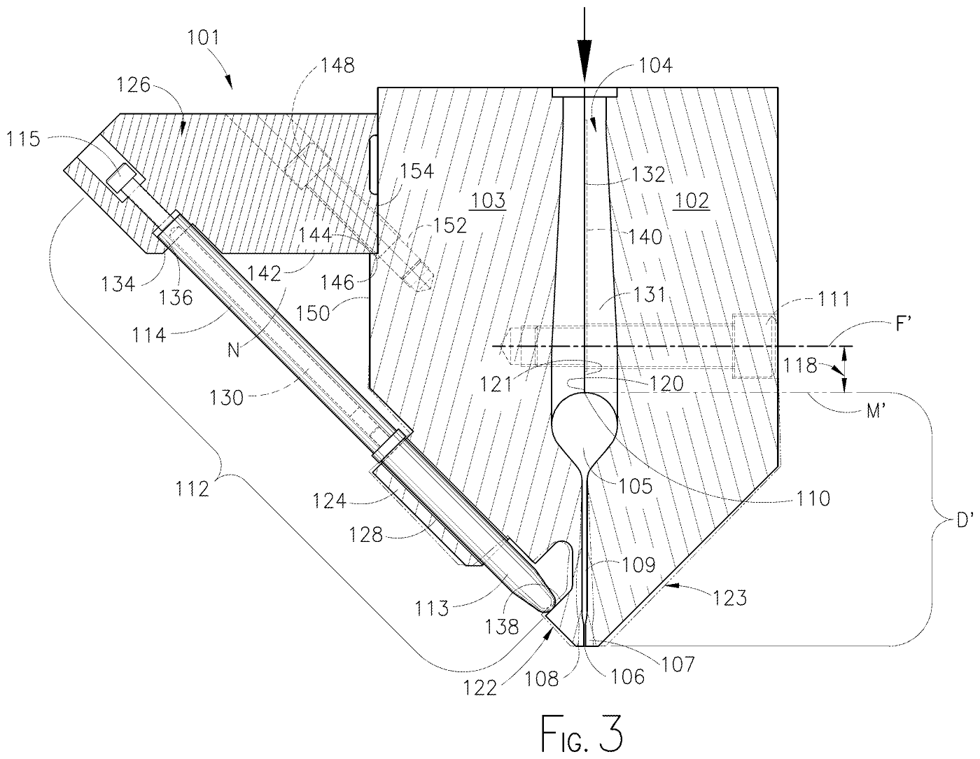

For purposes of convenience and brevity, like features in the embodiment of FIGS. 2 and 3 are indicated by like numbers and alphabetical letters used for FIG. 1. Thus, the description of FIG. 1 may be referred to, to the extent appropriate.

Although the embodiment illustrated by FIGS. 2 and 3 is a push-only lip adjustment system, one skilled in the art would understand how to modify this embodiment to be a push-pull adjustment system. See, for example, FIG. 1 of Cloeren '984 and the related description.

Referring now to FIG. 2, a preferred extrusion die 101 in accordance with the present invention is conveniently constructed of a first die body 102 and a second die body 103, and includes a plurality of automated exit orifice adjustment assemblies 112 spaced apart along the width W of die body 103 for providing discrete control along the width of the gap of exit orifice 106, which as illustrated may generally correspond to width W. Each automated adjustment assembly 112 comprises a thermally responsive translator 114, and conveniently includes an elongated push rod 113 to beneficially space thermal translator 114 away from die body 103, and an adjustment screw 115 (shown in FIG. 3) conveniently used to set the pre-load of adjustment assembly 112. Cover plates (not shown) conveniently shield thermal translators 114 (see cover plate 75, for example, of Cloeren '556).

Die body 103 further includes a guide structure 124 for adjustment assemblies 112, which are linearly movable. Engagement of push rods 113 with lip 108 is beneficially provided by contact of the push rods with a face 138 of the lip. The adjustable lip is preferably a flexible lip.

Referring now to FIG. 3, extrusion die 101 further includes a flow channel 104 that includes a flow channel inlet portion 131 in fluid communication with a transverse flow-providing manifold 105, and with exit orifice 106, which forms the gap between opposing lips 107, 108. Fluid communication between transverse flow-providing manifold 105, which includes a back line 110, and exit orifice 106 is conveniently provided by a flow channel portion 109. The main direction of fluid flow through flow channel 104 to exit orifice 106 is indicated by an enlarged arrow that points towards flow channel 104. Opposing die bodies 102, 103 are conveniently fastened together by body bolts 111 (one bolt indicated) suitably spaced apart from one another along die body width W.

Thermal translator 114 is an elongated member that advantageously includes an internal heating element 130 that may conveniently extend the length thereof. The heating element is beneficially connected to an electrical energy source for power control and corresponding actuation by thermal expansion and contraction of thermal translator 114.

Advantageously, as illustrated, a relatively greater portion of the length of thermal translator 114 is spaced away from (that is, not relatively near and not in generally parallel alignment with) a proximate face 150 of die body 103, and the entire length of thermal translator 114 is free of direct contact with die body 103. Accordingly, a relatively greater extent of elongated thermal translator 114 is beneficially spaced away from, and beneficially free of direct contact with, die body 103 than is relatively near, or in direct contact with, or in generally parallel alignment with, die body 103, such that thermal crosstalk with die body 103 is reduced, preferably negated. Elongated push rods 113 are beneficial to this objective. As may be understood, the further away that the extent of elongated thermal translator 114 is spaced apart from die body 103, the less the amount of thermal crosstalk between translators 114 and die body 103.

To further isolate thermal translators 114 from thermal crosstalk, a thermally insulating medium (not shown) may advantageously be interposed in triangular space N between thermal translators 114, and die body 103 and a support structure 126. Examples include glass fiber, synthetic fiber, synthetic insulation board, ceramic materials, heat-reflective media, and/or other beneficially suitable thermal insulation media.

With continued reference to FIG. 3, push rod 113 is in engagement with, and is conveniently disposed between, movable lip 108 and thermal translator 114. Thermal translator 114 is in engagement with, and is conveniently disposed between, push rod 113 and screw 115, which may be used as previously described. Alternatively, push rod 113 may be omitted, and thermal translator 114 may extend so as to be in engagement with face 138 of movable lip 108. In this variation, the lower end of thermal element 130 within the thermal translator may beneficially terminate upstream of, or at, die body projection 124. See FIG. 3 of Smith '084, for example.

As illustrated, an upper end 136 of thermal translator 114 conveniently extends to a face 134 of force-resistant structure 126 and beneficially engages with adjusting screw 115. Structure 126 conveniently extends across the width of die body 103, and is beneficially engaged by an abutment 144 and a plurality of fasteners 148 (one indicated) to secure structure 126 to die body 103. Structure 126 may be segmented, for ease of manufacture, across the width of die body 103. Force-resistant structure 126 is beneficially unitized with die body 103 upstream of manifold backline 110, preferably upstream of fulcrum line F′, and beneficially upstream of, and isolated from, deflection region D′ of extrusion die 101.

Die body face 150 may be conveniently undercut to form abutment 144, which is in engagement with a face 142 of structure 126. Face 142 and abutment 144 conveniently extend across the width of die body 103. Abutment 144 and a structural portion 146 of face 142 and fasteners 148 cooperate to secure and unitize structure 126 and die body 103. Fasteners 148 are each threaded into a die body bore 152. Beneficially, abutment 144 is generally parallel to exit orifice 106.

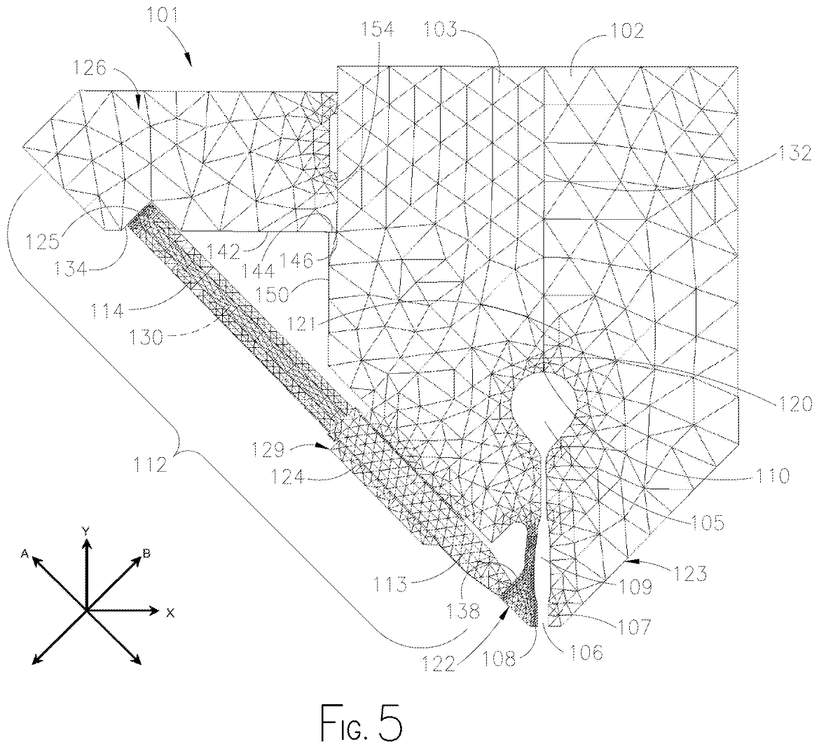

Advantageously, abutment 144, structural face 146, a base 154 of structure 126, and fasteners 148 are cooperatively arranged to resist the axial force (see axis A of FIG. 5) from lip adjustment assemblies 112 exerted upon force-resistant structure 126.

As can be appreciated by one skilled in the art, (i) the relative arrangement of features including structural face 146 and the corresponding abutment and fasteners may vary in numerous ways, while still maintaining the cooperative function of securely unitizing support structure 126 to die body 103, (ii) structure 126 may be unitized to die body 103 by welding, or (iii) structure 126 may be unitary with die body 103, all without deviating from the inventive benefit of the force-resistant structure being unitized with die body 103 upstream of manifold backline 110, preferably upstream of fulcrum line F′, and beneficially upstream of, and isolated from, deflection region D′ of extrusion die 101. Furthermore, in any event, support structure 126 is beneficially arranged to resist load transferred from lip adjustment assemblies 112, and thereby advantageously minimize energy consumption of thermal translators 114 for a given displacement of lip exit orifice 106.

Considering again the prior art die of FIG. 1, the further downstream from manifold backline 10 of extrusion die 1, the greater the displacement of die body 3 by operating pressure forces. Thus, in the context of the present invention, it is inconsistent for the lip adjustment assemblies to be supported downstream of manifold backline 11o insofar as they would be subject to flow pressure-induced deflection of die body 103 and displacement of the lip adjustment assemblies would be increased.

Guide structure 124 is a projection that conveniently extends outwardly from die body 103. Projection 124 includes a plurality of channels 128 (one shown) that conveniently function as a guide for the lower portion of each linearly movable, lip adjustment assembly 112, which in this embodiment is push rod 113. Unlike projection 24 of the prior art extrusion die of FIG. 1, which supports lip adjustment assemblies 12, projection 124 provides no other meaningful structural function than as a convenient guide means for linearly movable pushrods 113.

In operation, a fluid is extruded through exit orifice 106, and automated lip adjustment assemblies 112 including thermal translators 114, exert discrete forces on movable lip 108 as needed to adjust the gap of exit orifice 106 along width W to provide a web having a prescribed thickness profile. Under operating conditions, die bodies 102,103 are displaced in deflection region D′ by forces arising from the internal operating pressure within die flow channel portions 105,109 and 106 collectively, as illustratively depicted by phantom lines 122,123. The amount of deflection is less than that indicated by phantom lines 22,23 with respect to the prior art die of FIG. 1. Structure 126 advantageously functions in combination with automated lip adjustment assemblies 112 to resist lip displacement resulting from die body deflection so as to mitigate undesirable lip displacement.

To achieve a prescribed thickness uniformity across the width of the extruded web, discrete adjustments of the gap along the width of exit orifice 106 are provided by expansion and contraction of thermal translators 114 of automated lip adjustment assemblies 112. In a cast film extrusion process, no manual intervention to adjust the exit orifice gap via screws 115 has been found to be necessary to obtain and maintain a prescribed thickness profile of the extruded web (an unanticipated benefit believed uniquely different from the prior art and from today's industry standard linearly movable, thermal translator systems with which I am familiar).

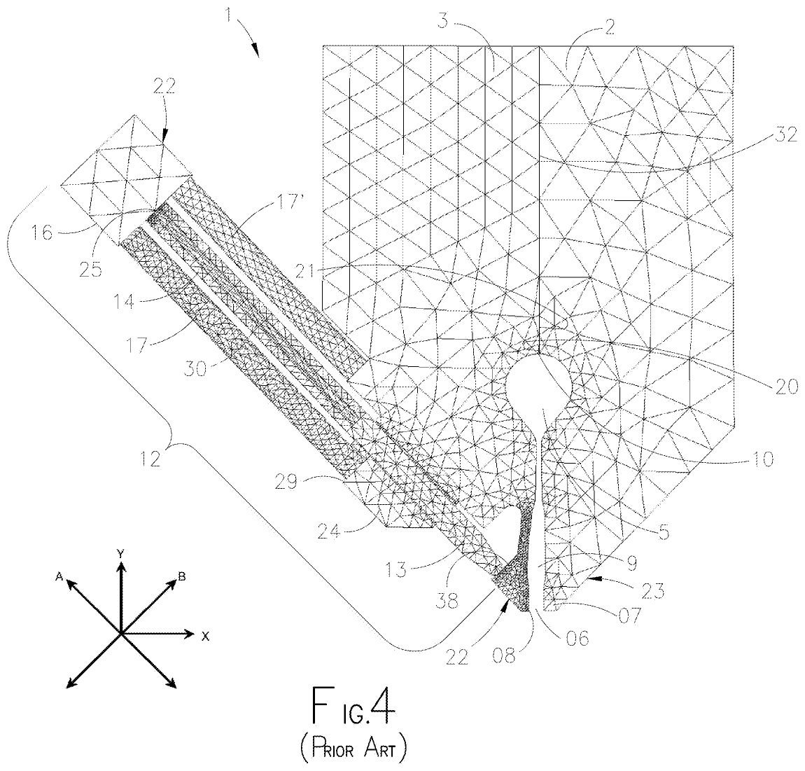

Referring to FIGS. 4 and 5, a Finite Elemental Analysis (FEA), using SolidWorks® Simulation software, compares displacement values along axes X, Y, B and axial axis A, resulting from flow pressure deflection forces, between the prior art apparatus of FIG. 1 and the preferred embodiment of FIGS. 2 and 3. For convenience of illustration, the scale of deformation is 20:1. With reference to FIGS. 4 and 5, the analysis data show that the displacement of movable lip 108 (FIG. 5) along the X-axis is reduced by 42%, or 116 microns (161 microns vs. 277 microns), when compared to the displacement of movable lip 8 of the prior art extrusion die of FIG. 1, with the same deflection forces imposed on the die bodies. This advantage substantially, if not exclusively, results from structure 126 being located upstream of deflection region D′ and upstream of fulcrum region 118, compared to structure 26 being cantilevered from projection 24, with projection 24 being located within deflection region D.

With reference to FIG. 4, the finite elemental analysis illustrates that node 29 located on projection 24 is pivoting (rotating) about fulcrum region 18. This pivoting, or rotating, results in a multi-axis (including axes A, B, X and Y) displacement of projection 24. With support 16 structurally cantilevered from projection 24, the displacement at node 25 is amplified. By contrast, with reference to FIG. 5, with structure 126 beneficially located behind fulcrum line F′ and isolated from deflection region D′, reduced displacement by flow-pressure deflection forces is realized at node 125 of structure 126.

The magnitude of multi-axis displacement can be quantified in terms of the energy required to compensate for the pressure induced displacement of respective lips 8,108. The FEA study shows that a temperature increase of 80° C. applied to thermal translator 14, is required to compensate for the deflection (277 μm) of lip 8. By comparison, the study shows that a temperature increase of 46° C. applied to thermal translator 114, compensates for deflection (161 μm) of lip 108, resulting in deflection compensation energy savings of 43% over the comparative prior art. This spared energy may be used to further facilitate the automated lip gap adjustment, thus contributing to the elimination of a need for manual intervention via adjustment screws 115 to control the prescribed thickness of the extrudate via adjustable exit office 106.

An extrusion die that includes a lip adjustment assembly generally consistent with the features of the preferred embodiment illustrated by FIGS. 2 and 3, has been evaluated in a cast film extrusion process. The die width is 3,000 mm and the nominal throughput rate is 1200 kg/hr. The die lip is preset to provide a predetermined exit orifice gap and the thermal translators are connected to an automated lip gap control system. A variety of polymers including LDPE, LLDPE, PP, OBC's and PET having vastly varying viscosities within each family group and between each family group, has been extruded and/or coextruded at varying throughput rates ranging from between about 500 kg/hr and about 1800 kg/hr. During evaluation, it has been found that no manual adjustment of the lip gap by lip adjusting screws was required. This finding was surprising and unexpected, and is revolutionary in my experience.

Various modifications have been described. The present invention may be carried out with other modifications without departing from the spirit or essential attributes thereof. Accordingly, reference should be made to the appended claims as indicating the scope of the invention.

1. An extrusion die providing improved control of the exit orifice gap,
said extrusion die comprising a die body and a plurality of thermally responsive translators, wherein said extrusion die further comprises a flow channel having a main flow direction and comprising an upstream flow channel portion in communication with a transverse-flow providing manifold and with a downstream flow channel portion comprising an exit orifice,
wherein said die body comprises a movable lip, and wherein said plurality of thermally responsive translators are linearly movable, and wherein said thermally responsive translators are disposed in a spaced away relationship from said die body for reducing thermal cross-talk of said thermally responsive translators with said die body, and
wherein a plurality of automated lip adjustment means comprising said thermally responsive translators are disposed between said movable lip and a support structure, wherein said support structure is secured to, or is unitary with, said die body at a location upstream of the backline of said transverse flow-providing manifold.

2. The extrusion die of claim 1, wherein a face of said support structure is in engagement with an abutment of said die body at said location.

3. The extrusion die of claim 1, wherein said location is upstream of a fulcrum region of said extrusion die.

4. The extrusion die of claim 1, wherein said location is upstream of a plurality of die body fasteners spaced along the width of said extrusion die.

5. The extrusion die of claim 1, wherein said support structure and said die body are unitized.

6. The extrusion die of claim 1, wherein said support structure is unitized to said die body by a plurality of support structure fasteners.

7. The extrusion die of claim 1, wherein the support structure is unitized to said die body by a welding.

8. The extrusion die of claim 1, wherein a relatively greater extent of each thermally responsive translator is spaced away from a generally parallel alignment with, than is in generally parallel alignment with, the proximate face of said die body.

9. The extrusion die of claim 1, wherein said thermal translators are configured to expand and contract in response to change by automated control input.

10. The extrusion die of claim 1, wherein the thermal translators are spaced apart from one another across the width of said exit orifice.

11. The extrusion die of claim 1, wherein said plurality of automated lip adjustment means are spaced along said movable lip for providing discrete adjustment of the exit orifice gap along the width of said exit orifice.

12. The extrusion die of claim 2, wherein a plurality of support structure fasteners fasten said support structure to said die body.

13. The extrusion die of claim 1, wherein engagement with said movable lip is by contact with a face of said movable lip.

14. The extrusion die of claim 1, wherein said movable lip is a flexible lip.

15. The extrusion die of claim 1, wherein said plurality of automated lip adjustment means comprise said plurality of thermally responsive translators in contact with a plurality of pushrods.
